(19) United States
(12) Patent Application Publication
(10) Pub. No.: US 2024/0266974 A1
(43) Pub. Date: Aug. 8, 2024

(54) DRIVE DEVICE AND VIBRATION WAVE MOTOR UNIT

(71) Applicant: CANON KABUSHIKI KAISHA, Tokyo (JP)

(72) Inventor: AKIRA SHIMADA, Saitama (JP)

(21) Appl. No.: 18/425,794

(22) Filed: Jan. 29, 2024

(30) Foreign Application Priority Data
Feb. 2, 2023 (JP) 2023-014478

(51) Int. Cl. H02N 2/02; G03B 3/10

(52) U.S. Cl. CPC H02N 2/026; G03B 3/10

(57) ABSTRACT

A drive device configured to relatively move a first member and a second member in a predetermined direction by using a vibration wave motor as a drive source includes a contact body, a vibrator including a protrusion coming into contact with the contact body and configured to generate vibration by a piezoelectric element to move the contact body in the predetermined direction, a pressurization mechanism configured to pressurize the vibrator against the contact body via a pressurization member in contact with the vibrator, and a first guide mechanism connected to at least one of the first member and the second member and configured to guide the relative movement, wherein one of the contact body and the pressurization mechanism is connected to the first member, and wherein the other of the contact body and the pressurization mechanism is connected to the second member.

### BACKGROUND

### Field of the Disclosure

The present disclosure relates to a drive device using a vibration wave motor as a drive source, and a vibration wave motor unit.

### Description of the Related Art

As a drive source of a drive device, a vibration wave motor that is a vibration actuator is used in some cases. For example, the vibration wave motor includes a vibrator in which two protrusions are provided on a front surface of a plate-like elastic body and an electromechanical energy conversion element such as a piezoelectric element is connected to a rear surface of the elastic body. An alternating-current voltage is applied to the electromechanical energy conversion element, to cause the two protrusions of the vibrator to perform elliptical motion or circular motion in a plane including a direction connecting the two protrusions and a direction in which the protrusions protrude. As a result, a contact body in contact with the two protrusions receives frictional drive force from the protrusions, and the vibrator and the contact body can be relatively moved in the direction connecting the two protrusions.

Japanese Patent Application Laid-Open No. 2021-173966 discusses a drive device including a holding member holding an optical element, a drive source (vibration wave motor) including a moving member, a transmission portion coupling the moving member and the holding member and transmitting power, and an urging mechanism urging the holding member against the moving member.

In a configuration in which the transmission portion transmitting power of the vibration wave motor includes a spherical member and a coupling-member urging spring to absorb positional deviation and to suppress occurrence of backlash, a distance from the vibrator to an output point is increased, which causes reduction in rigidity of an output transmission path.

### SUMMARY

The present disclosure is directed to a technique for preventing reduction of rigidity of an output transmission path in a case where a vibration wave motor is used as a drive source of a drive device.

According to an aspect of the present disclosure, a drive device configured to relatively move a first member and a second member in a predetermined direction by using a vibration wave motor as a drive source includes a contact body, a vibrator including a protrusion coming into contact with the contact body and configured to generate vibration by a piezoelectric element to move the contact body in the predetermined direction, a pressurization mechanism configured to pressurize the vibrator against the contact body via a pressurization member in contact with the vibrator, and a first guide mechanism connected to at least one of the first member and the second member and configured to guide the relative movement, wherein one of the contact body and the pressurization mechanism is connected to the first member, and wherein the other of the contact body and the pressurization mechanism is connected to the second member.

Further features of the present disclosure will become apparent from the following description of exemplary embodiments with reference to the attached drawings.

### BRIEF DESCRIPTION OF THE DRAWINGS

FIGS. 1A and 1B are perspective views each illustrating a slide unit according to one or more aspects of the present disclosure.

FIG. 2 is a partial cross-sectional view of the slide unit according to one or more aspects of the present disclosure.

FIGS. 3A and 3B are diagrams each illustrating a vibrator.

FIG. 4 is a front view of the slide unit according to one or more aspects of the present disclosure.

FIG. 5 is a diagram illustrating relationship between a pressurization mechanism and a contact body.

FIGS. 6A and 6B are perspective views each illustrating a slide unit according to one or more aspects of the present disclosure.

FIGS. 7A and 7B are perspective views each illustrating a vibration wave motor unit according to one or more aspects of the present disclosure.

FIGS. 8A and 8B are diagrams each illustrating a schematic configuration of an imaging apparatus according to one or more aspects of the present disclosure.

### DESCRIPTION OF THE EMBODIMENTS

Preferred exemplary embodiments of the present disclosure are to be described with reference to accompanying drawings.

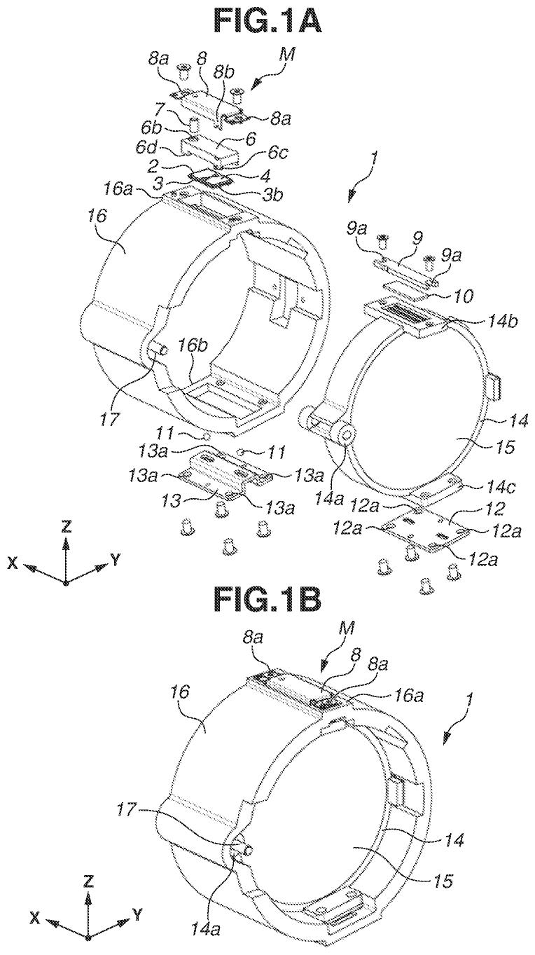

A first exemplary embodiment is to be described with reference to FIG. 1A to FIG. 5.

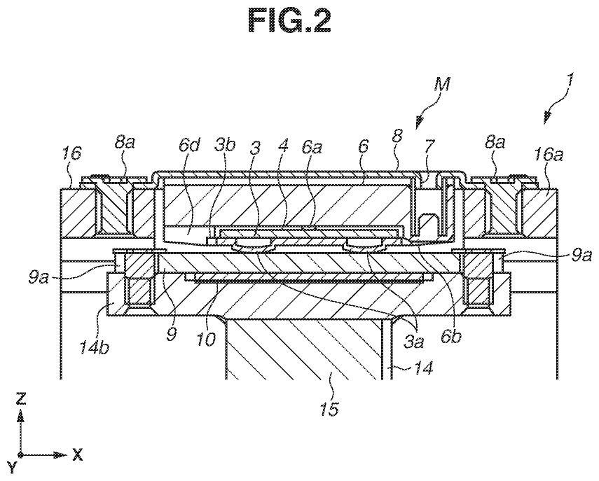

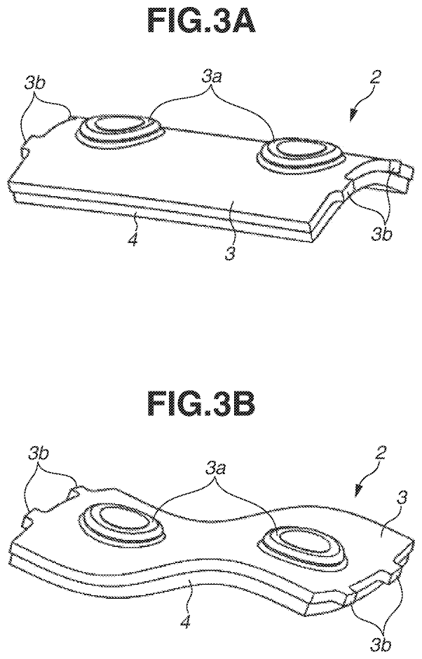

FIGS. 1A and 1B are perspective views each illustrating a slide unit 1 according to the first exemplary embodiment. FIG. 1A is an exploded view and FIG. 1B is an assembly diagram. The slide unit 1 is an example of a drive device to which the present exemplary embodiment is applied, and is integrated with a vibration wave motor M as a drive source. FIG. 2 is a partial cross-sectional view of the slide unit 1 (near vibration wave motor M). FIGS. 3A and 3B are diagrams each illustrating a vibrator 2 of the vibration wave motor M. A relative movement direction of the vibration wave motor M (direction in which vibrator 2 and contact body 9 contacting with vibrator 2 are relatively moved) is defined as an X direction, a direction orthogonal to the X direction is defined as a Y direction, and a direction orthogonal to the X direction and the Y direction is defined as a Z direction. In the present exemplary embodiment, a pressurization direction by a pressurization mechanism to be described below is the Z direction. A direction indicated by an arrow in the Z direction in FIGS. 1A and 1B is also referred to as an upward direction, and a direction opposite to the arrow is also referred to as a downward direction.

More specifically, the slide unit 1 is a lens barrel of an imaging apparatus, and includes an outer barrel 16 and a cylindrical frame 14 that is an inner barrel slidably assembled to an inside of the outer barrel 16. The frame 14 holds a lens 15 as an optical member. In the present exemplary embodiment, the outer barrel 16 corresponds to a first member, and the frame 14 corresponds to a second member and is a driven body.

In the slide unit 1, the vibration wave motor M as a linear motor is mounted in the following manner.

As illustrated in FIGS. 1A and 1B, an attachment portion 16a is provided at a top part (upper part in Z direction) of the outer barrel 16.

A reception portion 14b having a surface directed to the Z direction is provided at a top part of the frame 14. The vibration wave motor M is mounted using the attachment portion 16a and the reception portion 14b.

The vibration wave motor M includes the vibrator 2, a node pressor 6, a pressurization spring 7, an output transmission portion 8, and the contact body 9.

The vibrator 2 includes an elastic body 3 and a piezoelectric element 4. The elastic body 3 has a rectangular plate shape, and two protrusions 3a are provided on one (surface directed to inside of outer barrel 16 in radial direction) of surfaces as illustrated in FIG. 2 and FIGS. 3A and 3B. The protrusions 3a protrude in the Z direction (inward direction of outer barrel 16). The two protrusions 3a are arranged side by side in the X direction.

Extending portions 3b extending in the X direction are provided at both end parts of the elastic body 3 in the X direction. The extending portions 3b extend from a plurality of positions (two positions in this example) at each of the end parts of the elastic body 3 in the X direction. Thus, four extending portions 3b are provided in total.

The piezoelectric element 4 as an electromechanical energy conversion element is fixed to the other surface (surface directed to outside of outer barrel 16 in radial direction) of the elastic body 3 with an adhesive or the like. A flexible printed board (not illustrated) is fixed to a surface on a side opposite to the surface facing the elastic body 3, of the piezoelectric element 4. The piezoelectric element 4 and the flexible printed board are fixed with an anisotropic conductive paste or an anisotropic conductive film enabling energization only in the Z direction.

As a material of the elastic body 3, a material causing small attenuation of vibration, such as a metal and a ceramic is preferable. In manufacture of the elastic body 3, the protrusions 3a may be integrally formed by press molding, cutting, or the like, or the protrusions 3a may be separately manufactured and fixed later by welding, adhesion, or the like. Three or more protrusions 3a may be provided, or one protrusion 3a may be provided.

For example, lead zirconate titanate is used for the piezoelectric element 4. Alternatively, a material mainly containing a lead-free piezoelectric material such as barium titanate and bismuth sodium titanate may be used. Electrode patterns (not illustrated) are formed on both surfaces of the piezoelectric element 4, and power is supplied from the flexible printed board.

The node pressor 6 as a pressurization member for pressurizing the vibrator 2 is provided above the vibrator 2 in the Z direction. The cover-shaped output transmission portion 8 for covering the node pressor 6, and the pressurization spring 7 that is supported by the output transmission portion 8 and applies urging force to the node pressor 6 are provided.

More specifically, as illustrated in FIG. 2, a convex portion 6a coming into contact with the vibrator 2 is provided at a center of the node pressor 6. The convex portion 6a has an R shape at least at a front end part.

A spring reception portion 6b is provided at one end of the node pressor 6 in the X direction. The node pressor 6 includes a hole housing the pressurization spring 7, and a bottom part of the hole serving as the spring reception portion 6b receives the urging force by the pressurization spring 7. The node pressor 6 is pressurized downward in the Z direction by the pressurization spring 7 through the spring reception portion 6b, and reaction force thereof is received by the output transmission portion 8. The pressurization spring 7 is a compression coil spring, but a coil shape is omitted in illustration.

As illustrated in FIGS. 1A and 1B, a holding portion 6c that is a contact portion with the output transmission portion 8 is provided on the other end of the node pressor 6 in the X direction. The holding portion 6c has a cylindrical or semicylindrical shape protruding in the Y direction. On the other hand, a contact portion 8b having a V groove coming into contact with the holding portion 6c is provided on the output transmission portion 8. As described above, the node pressor 6 is held at the holding portion 6c so as to be swingable around the Y direction.

As illustrated in FIGS. 1A and 1B and FIG. 2, the node pressor 6 includes four stopper portions 6d. An outer shape of the elastic body 3 is used, and the four extending portions 3b of the elastic body 3 are loosely fitted into the respective stopper portions 6d, which positions the vibrator 2 and the node pressor 6 in the XY directions.

A configuration of the pressurization mechanism for pressurizing the vibrator 2 toward the contact body 9 through the node pressor 6 contacting with the vibrator 2 is as described above.

As illustrated in FIG. 2, as viewed from the X direction or the Y direction, the pressurization spring 7 and the node pressor 6 are overlapped, which makes it possible to achieve downsizing of the vibration wave motor M in the Z direction. In the node pressor 6, the spring reception portion 6b is provided at a portion lowered by one step. As a result, as viewed from the X direction or the Y direction, a part of the spring reception portion 6b and the vibrator 2 are overlapped, which makes it possible to achieve downsizing of the vibration wave motor M in the Z direction.

First connection portions 8a extending in the X direction are provided at both end parts of the output transmission portion 8 in the X direction, and the first connection portions 8a are fastened to the attachment portion 16a of the outer barrel 16 with screws. In the present exemplary embodiment, the first connection portions 8a are fastened to the attachment portion 16a with the screws. The first connection portions 8a, but may be connected to the outer barrel 16 by adhesion, press-fitting, swaging, welding, or the like. In the present exemplary embodiment, the output transmission portion 8 is directly connected to the outer barrel 16, but the output transmission portion 8 may be connected to the outer barrel 16 through another member in order to facilitate assembly as long as rigidity is not impaired.

In the present exemplary embodiment, the connection forms of each of the first connection portions 8a and second connection portions 9a include a form in which an element A and an element B are fixed by joining through a joining material, deposition, fitting, or engagement, other than fastening including screwing. Accordingly, the first connection portions 8a and the second connection portions 9a are also respectively referred to as first fixing portions 8a and second fixing portions 9a in some cases. The connection form of each of the first connection portions 8a and the second connection portions 9a is not limited to a connection form through a specific interface, and may be replaced with a form in which a member A and a member B are connected with predetermined concentration gradient through a transition region from the member A to the member B. The connection form of each of the first connection portions 8a and the second connection portions 9a may be a form in which an element A and an element A′ are integrally molded and uniformly connected.

The plate-like contact body 9 is provided below the vibrator 2 in the Z direction. The protrusions 3a of the vibrator 2 come into contact with the contact body 9 by pressurization force of the pressurization mechanism. A rubber 10 for attenuating vibration is disposed between the contact body 9 and the reception portion 14b of the frame 14.

As a material of the contact body 9, a metal, a ceramic, a resin, or a composite material thereof having high wear resistance is used. In particular, a nitride stainless-steel material such as SUS420J2 is preferable in terms of wear resistance and mass productivity.

The second connection portions 9a extending in the X direction are provided at both end parts of the contact body 9 in the X direction, and the second connection portions 9a are fastened to the reception portion 14b of the frame 14 with screws. In the present exemplary embodiment, the second connection portions 9a are fastened to the reception portion 14b with the screws, but the second connection portions 9a may be connected to the frame 14 by adhesion, press-fitting, swaging, welding, or the like. In the present exemplary embodiment, the contact body 9 is directly connected to the frame 14, but the contact body 9 may be connected to the frame 14 through another member in order to facilitate assembly as long as rigidity is not impaired.

The slide unit 1 includes a first guide mechanism and a second guide mechanism disposed at a position different from the first guide mechanism.

As illustrated in FIGS. 1A and 1B, the first guide mechanism is provided at a lower part of the slide unit 1 in the Z direction.

More specifically, a movable-side rail 12 as a second guide member is connected to a lower part of the frame 14 in the Z direction. The movable-side rail 12 is fastened to an attachment portion 14c of the frame 14 with screws through four corners serving as third connection portions 12a. A stationary-side rail 13 as a first guide member is connected to a lower part of the outer barrel 16 in the Z direction. The stationary-side rail 13 is fastened to an attachment portion 16b of the outer barrel 16 with screws through four corners serving as fourth connection portions 13a. In the present exemplary embodiment, the third connection portions 12a and the fourth connection portions 13a are respectively connected to the frame 14 and the outer barrel 16 by fastening with screws, but the third connection portions 12a and the fourth connection portions 13a may be respectively connected to the frame 14 and the outer barrel 16 by adhesion, press-fitting, swaging, welding, or the like.

Each of the movable-side rail 12 and the stationary-side rail 13 includes two V grooves arranged side by side in the X direction. A ball 11 is interposed between each V groove of the movable-side rail 12 and the corresponding V groove of the stationary-side rail 13, and is held between the V grooves by pressurization force of the pressurization mechanism. The first guide mechanism configured as described above can guide and slide the frame 14 in the X direction relative to the outer barrel 16. Because the first guide mechanism includes the balls 11 as rolling members, the movable-side rail 12 can smoothly move relative to the stationary-side rail 13, which makes it possible to smoothly slide the frame 14.

The second guide mechanism is provided on the slide unit 1. The second guide mechanism is disposed at a position different from a position of the first guide mechanism in a circumferential direction of the slide unit 1. In the present exemplary embodiment, the second guide mechanism is disposed on a side of the slide unit 1 in the Y direction.

More specifically, a part of the outer barrel 16 protrudes outward in the radial direction, and a bar 17 extending in the X direction is provided inside the part of the outer barrel 16. The frame 14 includes a sleeve 14a that includes a hole extending in the X direction, and the bar 17 is inserted into the sleeve 14a. The second guide mechanism configured as described above can guide and slide the frame 14 in the X direction relative to the outer barrel 16.

The first guide mechanism configured as described above regulates translational movement of the frame 14 in the Y direction and the Z direction, and rotational movement of the frame 14 around the Z axis, relative to the outer barrel 16. The second guide mechanism regulates rotational movement of the frame 14 around the X axis and rotational movement of the frame 14 around the Y axis, relative to the outer barrel 16. Accordingly, the frame 14 has only a freedom degree of translational movement in the X direction, the frame 14 can be precisely guided in the X direction, and the lens 15 can achieve desired optical performance.

A vibration mode excited in the vibrator 2 is to be described with reference to FIGS. 3A and 3B.

An alternating-current voltage is applied to the piezoelectric element 4 through the flexible printed board, to excite standing waves (out-of-plane bending vibrations) different in phase from each other in the vibrator 2, and vibration obtained by combining the out-of-plane bending vibrations is generated.

As illustrated in FIG. 3A, a mode A as a first vibration mode is a primary out-of-plane bending vibration mode in which two nodes appear in parallel to the X direction that is a longitudinal direction of the vibrator 2. By vibration in the mode A, the two protrusions 3a are displaced in the Z direction that is the pressurization direction.

As illustrated in FIG. 3B, a mode B as a second vibration mode is a secondary out-of-plane bending vibration mode in which three nodes appear in substantially parallel to the Y direction that is a transverse direction of the vibrator 2. By vibration in the mode B, the two protrusions 3a are displaced in the X direction.

When the vibration in the mode A and the vibration in the mode B are combined, the two protrusions 3a perform elliptical motion or circular motion in the XZ plane. When the contact body 9 is brought into pressure contact with the protrusions 3a, frictional force is generated in the X direction, and drive force (thrust force) relatively moving the vibrator 2 and the contact body 9 is generated. In the present exemplary embodiment, the vibrator 2 is fixed, and the contact body 9 moves in the X direction.

To efficiently drive the vibration wave motor M, it is necessary to support the vibrator 2 without inhibiting vibrations (displacements) of the two vibration modes excited in the vibrator 2. To do so, it is desirable to support portions near the nodes of the two vibration modes. For such a reason, the convex portion 6a of the node pressor 6 is provided at a position in contact with a node common to the two vibration modes excited in the vibrator 2.

The convex portion 6a not only pressurizes the vibrator 2, but also holds the vibrator 2 in the X direction and the Y direction by frictional force. When the contact body 9 is moved, the maximum value of static frictional force between the convex portion 6a and the vibrator 2 is constantly greater than reaction force applied to the vibrator 2, and accordingly, the vibrator 2 does not move relative to the node pressor 6. This makes it possible to precisely drive the slide unit 1. As described above, because the node pressor 6 is pressurized and held by the output transmission portion 8 through the holding portion 6c, the node pressor 6 does not move in the X direction.

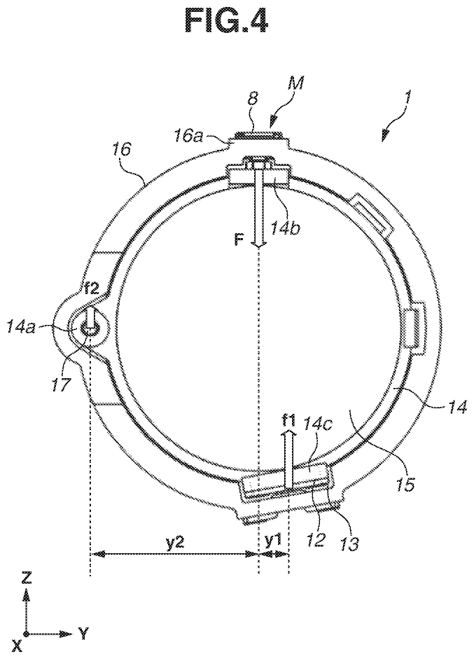

Distribution of pressurization is to be described with reference to FIG. 4. FIG. 4 is a front view of the slide unit 1 (as viewed from X direction).

As described above, the vibrator 2 is pressurized in the Z direction, and pressurization force is denoted by F. Force received by the first guide mechanism, of the pressurization force F is denoted by f1, and force received by the second guide mechanism, of the pressurization force F is denoted by f2. A distance in the Y direction from a contact portion between the vibrator 2 and the contact body 9 to a center of the balls 11 of the first guide mechanism is denoted by y1, and a distance from the contact portion to a center of the bar 17 of the second guide mechanism is denoted by y2.

Loss of the first guide mechanism when the frame 14 moves is caused by rolling friction. For this reason, a friction coefficient is small, and the first guide mechanism can receive relatively large force. In contrast, slide friction occurs on the second guide mechanism. Accordingly, a friction coefficient is large, and if large force is received by the second guide mechanism, loss may occur.

However, a minute gap (backlash) is present between the sleeve 14a and the bar 17 in the Z direction. For this reason, to precisely move the frame 14, it is necessary to urge the frame 14 with force at least greater than or equal to the mass of the frame 14.

When the distances y1 and y2 are maintained in proper balance, the second guide mechanism can be urged with minimum force while most of the pressurization force by the pressurization mechanism is received by the first guide mechanism. A ratio of the distances y1 and y2 (y1:y2) is desirably about 1:4 to 1:10.

The distance y1 can be set to zero. In this case, for example, a magnet is disposed on the frame 14, and a magnetic material such as SUS420J is used for the bar 17, thereby gathering backlash by magnetic force.

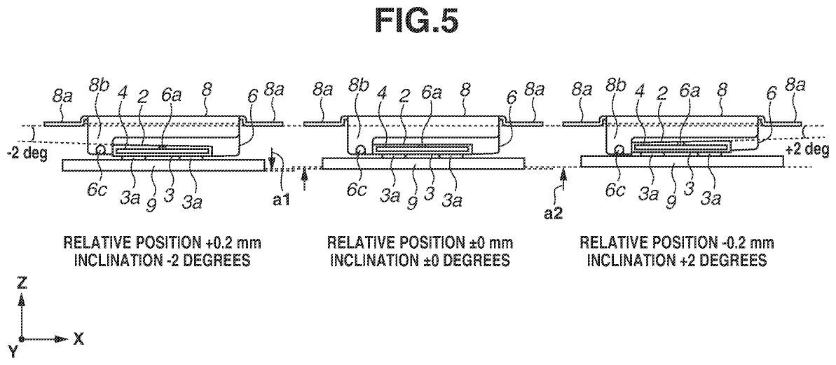

Absorption of manufacturing variation is to be described with reference to FIG. 5. FIG. 5 is a diagram illustrating relationship between the pressurization mechanism and the contact body 9.

As described above, the contact body 9 is directly fastened to the frame 14 with screws, and the output transmission portion 8 is directly fastened to the outer barrel 16 with screws. Accordingly, to cause predetermined pressurization force to act on the vibrator 2 even in a case where a manufacturing error (in particular, in Z direction) or the like occurs on each component, it is necessary to take some kind of measure.

In FIG. 5, a center diagram illustrates a state where a fastening surface of the output transmission portion 8 and a fastening surface of the contact body 9 are at positions of reference values. Right and left diagrams illustrate states where a relative position of the fastening surfaces is displaced from the position of the reference value by ±0.2 mm in the Z direction (see arrows a1 and a2).

In a case where the relative position of the fastening surfaces is displaced by +0.2 mm as illustrated in the left diagram of FIG. 5, the node pressor 6 is inclined by about −2 degrees with the holding portion 6c as a center. The convex portion 6a has the R shape. Accordingly, even when the node pressor 6 is inclined, the inclination of the node pressor 6 does not affect contact of the convex portion 6a with the vibrator 2. On the other hand, an operation length of the pressurization spring 7 is increased. Accordingly, the pressurization force is reduced, but the predetermined pressurization force is obtainable by setting a spring constant of the pressurization spring 7 to an appropriate value.

In a case where the relative position of the fastening surfaces is displaced by −0.2 mm as illustrated in the right diagram of FIG. 5, the node pressor 6 is inclined by about +2 degrees with the holding portion 6c as a center. The convex portion 6a has the R shape. Accordingly, even when the node pressor 6 is inclined, the inclination of the node pressor 6 does not affect contact of the convex portion 6a with the vibrator 2. On the other hand, the operation length of the pressurization spring 7 is reduced. Therefore, the pressurization force is increased, but the predetermined pressurization force is obtainable by setting the spring constant of the pressurization spring 7 to an appropriate value.

As described above, because the contact body 9 is connected to the frame 14, and the output transmission portion 8 of the pressurization mechanism is connected to the outer barrel 16, it is possible to prevent reduction of the rigidity of the output transmission path, and to precisely drive the slide unit 1.

Because a coupling member for transmitting the driving force only in the X direction is not used, and the linear guide is made common to the frame 14, it is possible to achieve drastic downsizing and reduction of the number of components.

In the linear vibration wave motor, the method of causing the elliptical motion or the circular motion of the contact surface is not limited to the above-described method. For example, vibrations of bending vibration modes different from the bending vibration modes described in FIGS. 3A and 3B may be combined, or vibration of a vertical vibration mode expanding/contracting the elastic body 3 in the longitudinal direction and vibration of the bending vibration mode may be combined.

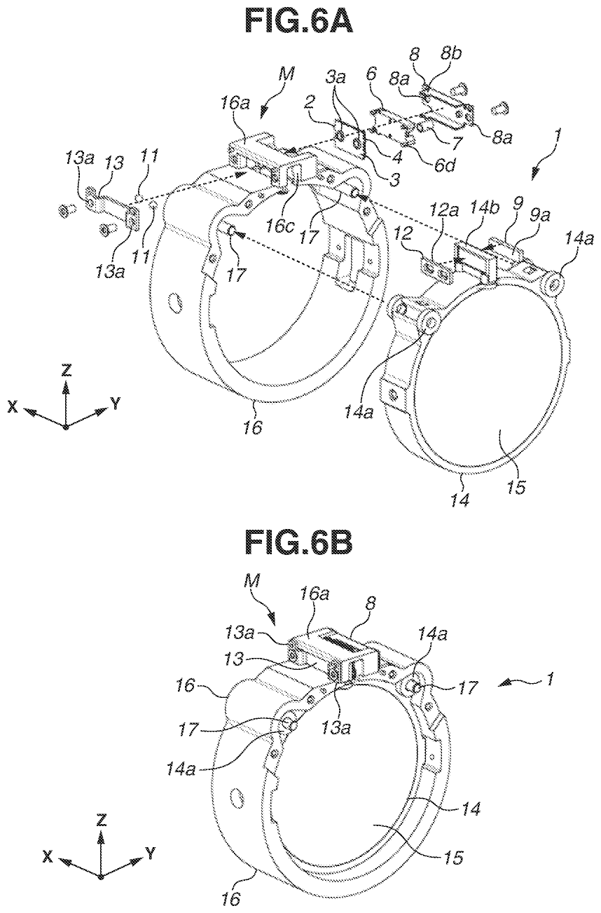

A second exemplary embodiment is to be described with reference to FIGS. 6A and 6B.

FIGS. 6A and 6B are perspective views each illustrating the slide unit 1 according to the second exemplary embodiment. FIG. 6A is an exploded view, and FIG. 6B is an assembly diagram.

Components corresponding to the components of the slide unit 1 according to the first exemplary embodiment are denoted by the same reference numerals, and differences from the first exemplary embodiment are to be mainly described.

In the second exemplary embodiment, a direction of the vibration wave motor M is changed from that of the first exemplary embodiment. Accordingly, in the present exemplary embodiment, the pressurization direction by the pressurization mechanism is the Y direction.

In contrast to the first exemplary embodiment, shapes of the attachment portion 16a and the reception portion 14b to which the vibration wave motor M is attached are changed, and the first guide mechanism is provided using the attachment portion 16a and the reception portion 14b.

More specifically, as illustrated in FIGS. 6A and 6B, the attachment portion 16a is provided at the top part of the outer barrel 16. The plate-like reception portion 14b having a surface directed to the Y direction is provided at the top part of the frame 14. The attachment portion 16a includes a concave portion 16c through which the reception portion 14b goes in and out. In a state where the frame 14 is assembled to the outer barrel 16, the reception portion 14b overlaps the attachment portion 16a as viewed from the X direction or the Y direction.

In the present exemplary embodiment, the plate-like contact body 9 is bonded to one of surfaces in the Y direction of the reception portion 14b of the frame 14. In other words, the surface of the contact body 9 serves as the second connection portion 9a. The second connection portion 9a may be connected to the frame 14 by fastening with screws, press-fitting, swaging, welding, or the like, as described in the first exemplary embodiment.

The movable-side rail 12 is connected to the other surface in the Y direction of the reception portion 14b. The movable-side rail 12 is bonded to the reception portion 14b through the surface serving as the third connection portion 12a. The third connection portion 12a may be connected to the frame 14 by fastening with screws, press-fitting, swaging, welding, or the like, as described in the first exemplary embodiment.

As described above, the contact body 9 and the movable-side rail 12 are disposed to face each other with the reception portion 14b in between.

In the present exemplary embodiment, the vibrator 2 and the pressurization mechanism (node pressor 6, pressurization spring 7, and output transmission portion 8) are assembled to the attachment portion 16a of the outer barrel 16 from one side in the Y direction.

The first connection portions 8a of the output transmission portion 8 are fastened to the attachment portion 16a of the outer barrel 16 with screws. The first connection portions 8a may be connected to the outer barrel 16 by adhesion, press-fitting, swaging, welding, or the like, as described in the first exemplary embodiment.

The stationary-side rail 13 is connected to the attachment portion 16a from the other side in the Y direction.

The fourth connection portions 13a extending in the X direction are provided at both end parts of the stationary-side rail 13 in the X direction, and the fourth connection portions 13a are fastened to the attachment portion 16a with screws. The fourth connection portions 13a may be connected to the outer barrel 16 by adhesion, press-fitting, swaging, welding, or the like, as described in the first exemplary embodiment. In the present exemplary embodiment, a V groove is provided in the movable-side rail 12, whereas a surface of the stationary-side rail 13 on the ball 11 side is flat.

In the present exemplary embodiment, the second guide mechanisms (each including bar 17 and sleeve 14a) are provided at two positions of the slide unit 1. The second guide mechanisms are disposed on both sides with the vibration wave motor M and the first guide mechanism in between in the circumferential direction of the slide unit 1. In this case, the holes of the sleeves 14a are formed as long holes radially extending from an optical center of the optical member 15, to absorb a manufacturing error and the like.

The first guide mechanism and the second guide mechanisms configured as described above constrain movement of the frame 14 in the directions other than the X direction relative to the outer barrel 16, which makes it possible to precisely guide the frame 14 in the X direction.

As described above, as in the first exemplary embodiment, the contact body 9 is connected to the frame 14, and the output transmission portion 8 of the pressurization mechanism is connected to the outer barrel 16. This makes it possible to prevent reduction of the rigidity of the output transmission path, and to precisely drive the slide unit 1.

In the present exemplary embodiment, the contact body 9 and the movable-side rail 12 are connected to the reception portion 14b, thereby preventing a vector of the pressurization force from passing through the optical member 15. Accordingly, the pressurization force is not applied to the lens 15. Even in a case of using a lens made of a material low in rigidity, for example, a resin, it is possible to prevent deformation of the lens and to maintain excellent optical performance.

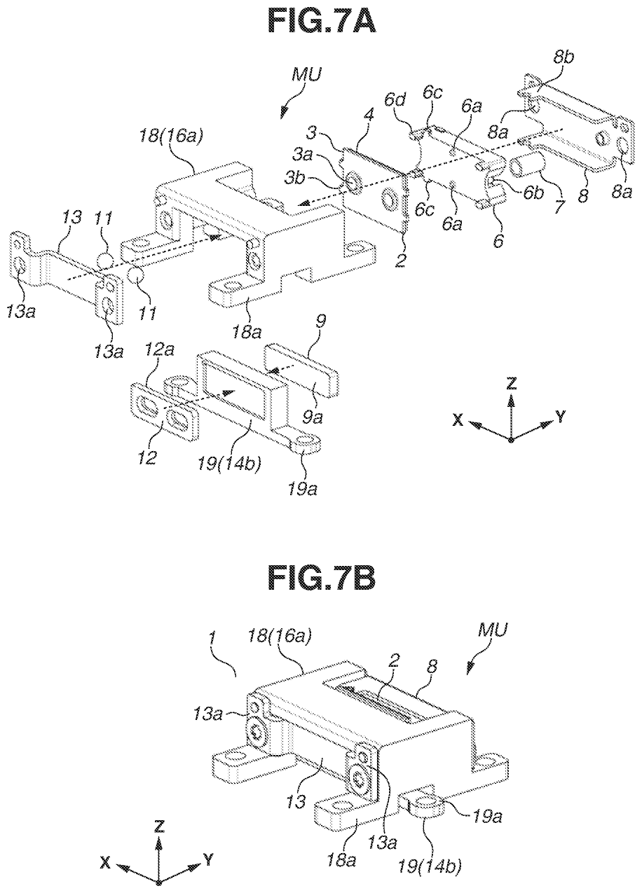

A third exemplary embodiment is to be described with reference to FIGS. 7A and 7B.

FIGS. 7A and 7B are perspective views each illustrating a vibration wave motor unit according to the third exemplary embodiment. FIG. 7A is an exploded view, and FIG. 7B is an assembly diagram.

In the second exemplary embodiment, the configuration example in which the vibration wave motor M is integrated with the slide unit 1 is described. In the third exemplary embodiment, a vibration wave motor unit as an independent member is to be described. A vibration wave motor unit MU according to the third exemplary embodiment is to be described in comparison with the second exemplary embodiment.

The vibration wave motor unit MU includes a first attachment member 18 attached to the outer barrel 16, and a second attachment member 19 attached to the frame 14. The first attachment member 18 serves as a base for the vibration wave motor unit MU. The first attachment member 18 is a member corresponding to the attachment portion 16a in the second exemplary embodiment, and includes fastening portions 18a to be fastened to the outer barrel 16 with screws. The second attachment member 19 is a member corresponding to the reception portion 14b in the second exemplary embodiment, and includes fastening portions 19a to be fastened to the frame 14 with screws.

The vibrator 2, the pressurization mechanism (node pressor 6, pressurization spring 7, and output transmission portion 8), the contact body 9, and the first guide mechanism (balls 11, movable-side rail 12, and stationary-side rail 13) are similar to those in the second exemplary embodiment, and description thereof is omitted.

The present exemplary embodiment uses the vibration wave motor unit independent of the slide unit while achieving effects similar to the effects by the second exemplary embodiment. For this reason, replacement when an abnormality occurs is easily performable.

The contact body 9 is connected to the driven body (frame 14), but the contact body 9 may be connected to a stationary side (outer barrel 16), and the output transmission portion 8 of the pressurization mechanism may be fastened to the driven body.

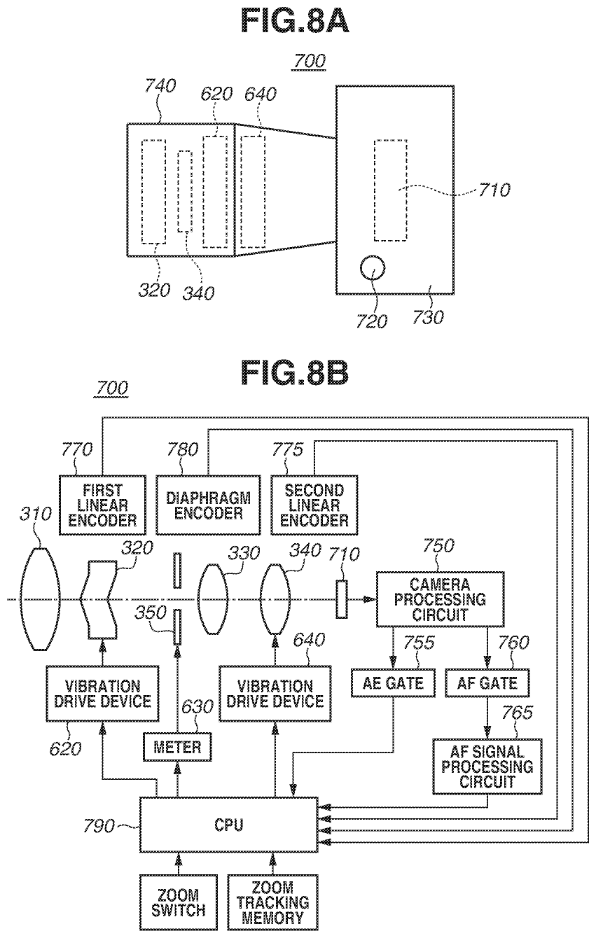

A fourth exemplary embodiment is to be described with reference to FIGS. 8A and 8B.

For example, the vibration wave motor can be used for driving a lens of an imaging apparatus (optical apparatus or electronic apparatus).

In the fourth exemplary embodiment, an example of an imaging apparatus using the vibration wave motor to drive a lens is to be described.

FIG. 8A is a top view illustrating a schematic configuration of an imaging apparatus 700. The imaging apparatus 700 includes a camera main body 730 including an imaging element 710 and a power button 720. The imaging apparatus 700 includes a lens barrel 740 that includes a first lens group 310 (not illustrated), a second lens group 320, a third lens group 330 (not illustrated), a fourth lens group 340, and vibration drive devices (vibration wave motors) 620 and 640. The lens barrel 740 is interchangeable as an interchangeable lens, and the lens barrel 740 suitable for an imaging object can be mounted on the camera main body 730. In the imaging apparatus 700, the second lens group 320 and the fourth lens group 340 are driven by the vibration drive devices 620 and 640, respectively.

The vibration drive device 620 includes the vibration wave motor, and a drive circuit of the vibration wave motor. The vibration drive device 620 moves the second lens group 320 in an optical axis direction. The vibration drive device 640 is configured in a similar manner to the vibration drive device 620, and moves the fourth lens group 340 in the optical axis direction.

FIG. 8B is a block diagram illustrating a schematic configuration of the imaging apparatus 700.

The first lens group 310, the second lens group 320, the third lens group 330, the fourth lens group 340, and a light quantity control unit 350 are arranged at predetermined positions on an optical axis inside the lens barrel 740. Light having passed through the first lens group 310 to the fourth lens group 340 and the light quantity control unit 350 forms an optical image on the imaging element 710. The imaging element 710 converts the optical image into an electric signal and outputs the electric signal, and the output electric signal is transmitted to a camera processing circuit 750.

The camera processing circuit 750 performs amplification, gamma correction, and the like on the output electric signal from the imaging element 710. The camera processing circuit 750 is connected to a central processing unit (CPU) 790 through an autoexposure (AE) gate 755, and is connected to the CPU 790 through an autofocus (AF) gate 760 and an AF signal processing circuit 765. An image signal subjected to predetermined processing by the camera processing circuit 750 is transmitted to the CPU 790 through the AE gate 755, and the AF gate 760 and the AF signal processing circuit 765.

The AF signal processing circuit 765 extracts high-frequency components of the image signal to generate an evaluation value signal for autofocus, and supplies the generated evaluation value signal to the CPU 790.

The CPU 790 is a control circuit for controlling overall operation of the imaging apparatus 700, and generates a control signal for determination of exposure and focusing from the acquired image signal. To obtain the determined exposure and an appropriate focus state, the CPU 790 adjusts positions of the second lens group 320, the fourth lens group 340, and the light quantity control unit 350 in the optical axis direction by controlling driving of the vibration drive devices 620 and 640 and a meter 630. Under the control of the CPU 790, the vibration drive device 620 moves the second lens group 320 in the optical axis direction, the vibration drive device 640 moves the fourth lens group 340 in the optical axis direction, and the light quantity control unit 350 is driven and controlled by the meter 630.

The position in the optical axis direction of the second lens group 320 driven by the vibration drive device 620 is detected by a first linear encoder 770, and a detection result is notified to the CPU 790 and is fed back to driving of the vibration drive device 620. Likewise, the position in the optical axis direction of the fourth lens group 340 driven by the vibration drive device 640 is detected by a second linear encoder 775, and a detection result is notified to the CPU 790 and is fed back to driving of the vibration drive device 640. The position of the light quantity control unit 350 in the optical axis direction is detected by a diaphragm encoder 780, and a detection result is notified to the CPU 790 and is fed back to driving of the meter 630.

Although the present disclosure is described together with the exemplary embodiments, the above-described exemplary embodiments are merely specific examples for implementing the present disclosure, and the technical scope of the present disclosure should not be construed in a limited manner by the above-described exemplary embodiments. In other words, the present disclosure can be implemented in various forms without departing from the technical idea or main features of the present disclosure.

Disclosure of the exemplary embodiments encompasses the following configurations.

### Configuration 1

A drive device configured to relatively move a first member and a second member in a predetermined direction by using a vibration wave motor as a drive source, the drive device including:
a contact body;
a vibrator including a protrusion coming into contact with the contact body, and configured to generate vibration by a piezoelectric element to move the contact body in the predetermined direction;
a pressurization mechanism configured to pressurize the vibrator against the contact body via a pressurization member in contact with the vibrator; and
a first guide mechanism connected to at least one of the first member and the second member, and configured to guide the relative movement,
in which one of the contact body and the pressurization mechanism is connected to the first member, and
in which the other of the contact body and the pressurization mechanism is connected to the second member.

### Configuration 2

The drive device according to configuration 1, further including a second guide mechanism disposed at a position different from a position of the first guide mechanism, and configured to guide the relative movement.

### Configuration 3

The drive device according to configuration 2, in which force received by the first guide mechanism, of pressurization force of the pressurization mechanism is made greater than force received by the second guide mechanism.

### Configuration 4

The drive device according to any one of configurations 1 to 3, in which the first guide mechanism includes a first guide member connected to the first member, a second guide member connected to the second member, and a rolling member provided between the first guide member and the second guide member.

### Configuration 5

The drive device according to any one of configurations 1 to 4, in which the contact body and the pressurization mechanism are connected to the first member and the second member by any of fastening with screws, adhesion, press-fitting, swaging, and welding.

### Configuration 6

The drive device according to any one of configurations 1 to 5,
in which the first member is an outer barrel, and
in which the second member is an inner barrel slidably assembled to an inside of the outer barrel.

### Configuration 7

The drive device according to any one of configurations 1 to 6,
in which the drive device moves the second member relative to the first member,
in which the pressurization mechanism is connected to the first member, and
in which the contact body is connected to the second member.

### Configuration 8

The drive device according to configuration 7,
in which the first guide mechanism includes a first guide member connected to the first member, and a second guide member connected to the second member, and
in which the contact body and the second guide member are connected to a reception portion provided on the second member.

### Configuration 9

The drive device according to configuration 8, in which the contact body and the second guide member are disposed to face each other with the reception portion in between.

### Configuration 10

The drive device according to any one of configurations 7 to 9,
in which the first member is an outer barrel of a lens barrel, and
in which the second member is a cylindrical frame slidably assembled to an inside of the outer barrel and holding an optical member.

### Configuration 11

A vibration wave motor unit used as a drive source configured to relatively move a first member and a second member in a predetermined direction, the vibration wave motor unit including:
a first attachment member attached to the first member;
a second attachment member attached to the second member;
a contact body;
a vibrator including a protrusion coming into contact with the contact body, and configured to generate vibration by a piezoelectric element to move the contact body in the predetermined direction;
a pressurization mechanism configured to pressurize the vibrator against the contact body via a pressurization member in contact with the vibrator; and
a first guide mechanism connected to at least one of the first member and the second member, and configured to guide the relative movement,
in which one of the contact body and the pressurization mechanism is connected to the first attachment member, and
in which the other of the contact body and the pressurization mechanism is connected to the second attachment member.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-014478, filed Feb. 2, 2023, which is hereby incorporated by reference herein in its entirety.

What is claimed is:

1. A drive device configured to relatively move a first member and a second member in a predetermined direction by using a vibration wave motor as a drive source, the drive device comprising:
a contact body;
a vibrator including a protrusion coming into contact with the contact body, and configured to generate vibration by a piezoelectric element to move the contact body in the predetermined direction;
a pressurization mechanism configured to pressurize the vibrator against the contact body via a pressurization member in contact with the vibrator; and
a first guide mechanism connected to at least one of the first member and the second member, and configured to guide the relative movement,
wherein one of the contact body and the pressurization mechanism is connected to the first member, and
wherein the other of the contact body and the pressurization mechanism is connected to the second member.

2. The drive device according to claim 1, further comprising a second guide mechanism disposed at a position different from a position of the first guide mechanism, and configured to guide the relative movement.

3. The drive device according to claim 2, wherein force received by the first guide mechanism, of pressurization force of the pressurization mechanism is made greater than force received by the second guide mechanism.

4. The drive device according to claim 1, wherein the first guide mechanism includes a first guide member connected to the first member, a second guide member connected to the second member, and a rolling member provided between the first guide member and the second guide member.

5. The drive device according to claim 1, wherein the contact body and the pressurization mechanism are connected to the first member and the second member by any of fastening with screws, adhesion, press-fitting, swaging, and welding.

6. The drive device according to claim 1,
wherein the first member is an outer barrel, and
wherein the second member is an inner barrel slidably assembled to an inside of the outer barrel.

7. The drive device according to claim 1,
wherein the drive device moves the second member relative to the first member,
wherein the pressurization mechanism is connected to the first member, and
wherein the contact body is connected to the second member.

8. The drive device according to claim 7,
wherein the first guide mechanism includes a first guide member connected to the first member, and a second guide member connected to the second member, and
wherein the contact body and the second guide member are connected to a reception portion provided on the second member.

9. The drive device according to claim 8, wherein the contact body and the second guide member are disposed to face each other with the reception portion in between.

10. The drive device according to claim 7,
wherein the first member is an outer barrel of a lens barrel, and
wherein the second member is a cylindrical frame slidably assembled to an inside of the outer barrel and holding an optical member.

11. An optical apparatus comprising:
the drive device according to claim 1; and
an optical member held by at least one of the first member and the second member.

12. An imaging apparatus comprising:
the drive device according to claim 1; and
an imaging element held by at least one of the first member and the second member.

13. An electronic apparatus comprising:
the drive device according to claim 1; and
a drive object held by at least one of the first member and the second member.

14. A vibration wave motor unit used as a drive source configured to relatively move a first member and a second member in a predetermined direction, the vibration wave motor unit comprising:
a first attachment member attached to the first member;
a second attachment member attached to the second member;
a contact body;
a vibrator including a protrusion coming into contact with the contact body, and configured to generate vibration by a piezoelectric element to move the contact body in the predetermined direction;
a pressurization mechanism configured to pressurize the vibrator against the contact body via a pressurization member in contact with the vibrator; and
a first guide mechanism connected to at least one of the first member and the second member, and configured to guide the relative movement,
wherein one of the contact body and the pressurization mechanism is connected to the first attachment member, and
wherein the other of the contact body and the pressurization mechanism is connected to the second attachment member.
